(19) United States
(12) Patent Application Publication
(10) Pub. No.: US 2017/0094159 A1
(43) Pub. Date: Mar. 30, 2017

(54) METHOD FOR INITIATING PHOTOGRAPHIC IMAGE CAPTURE USING EYEGAZE TECHNOLOGY

(71) Applicant: The Eye Tribe Aps, Denmark (DK)

(72) Inventor: Jonas Priesum, Copenhagen (DK)

(73) Assignee: The Eye Tribe, Copenhagen (DK)

(21) Appl. No.: 15/288,178

(22) Filed: Oct. 7, 2016

Related U.S. Application Data
(60) Provisional application No. 62/232,357, filed on Sep. 24, 2015.

(51) Int. Cl. H04N 5/232

(52) U.S. Cl. CPC H04N 5/23219; H04N 5/23245

(57) ABSTRACT

The invention is a method for bypassing a locked system, invoking a camera application, and initiating a photographic image capture all using eye tracking technology and a user's gaze at a system's camera sensor.

### TECHNICAL FIELD

The present invention relates to a system control using eye tracking

### BACKGROUND OF THE INVENTION

The greatest numbers of devices currently in use for capturing and storing images are found in cellular telephony systems, such as feature phones and smartphones. Their numbers far exceed those of systems designed solely for photography, such as digital cameras. In addition, other devices, such as tablets, music players, and laptops may include camera modules and support taking photographic images. Most camera technology incorporated in cellular systems and others require a user to make the device operational, select a camera mode, and initiate photo “taking” by pressing a physical button or touching a touch-screen icon. The time from deciding to take a photograph and actually doing so can take tens of seconds. In addition, many of contemporary cellular telephony systems have so-called front and rear camera sensors (e.g. lens and sensors) so that users may take photos of themselves, or photos of other objects. Switching between front and rear camera sensors also typically involves an additional method step.

### BRIEF SUMMARY OF THE INVENTION

By combining cellular telephony apparatus features and functions with eye tracking technology, one can initiate a photographic capture sequence by gazing at a camera sensor. For example, while holding a smartphone with the screen facing the user, the user can gaze at the camera sensor and initiate a self-portrait using a front-facing sensor. Alternatively, a user could aim a rear-facing sensor at an object, and when ready, gaze at the front-facing sensor and automatically “take the shot.” The eye tracking technology could also be used to enable a camera that is on, but locked, to take a photograph without first having to enter an unlocking code. The ability to initiate photographic image capture with eye tracking technology could therefore be used to reduce the time and physical manipulation required to take photographs. This same capability could be employed with other systems, such as laptops, tablets, and music players that include electronic camera technology and functions.

The method herein disclosed and claimed takes advantage of an existing system's optical sensing, processing, and control subsystems to incorporate eye tracking technology as a way of initiating photographic image capture.

Another method embodiment could circumvent function-lock-status state to initiate photographic image capture by an otherwise functionally locked system.

### BRIEF DESCRIPTIONS OF THE DRAWINGS

FIG. 1 depicts a person holding a smartphone system and gazing at a front-facing camera sensor.

FIG. 2 is a flow diagram of one method embodiment where eye tracking is used to initiate photographic image capture.

FIG. 3 is a flow diagram of another method embodiment where eye tracking is used to launch the camera application then used to initiate a photographic image capture.

FIG. 4 illustrates a sequence in which (left to right) a locked smartphone with keypad showing is gazed at such that eye tracking shows the eye fixed on the camera sensor. That unlocks the camera application and a front-facing sensor image is displayed while the person continues to gaze at the camera sensor. After some time interval, a photographic image is captured and stored in the photo gallery.

### DETAILED DESCRIPTION OF THE INVENTION

Currently, digital camera subsystems incorporated into cellular telephony systems and other multipurpose systems constitute the greatest number of photographic image capture systems. Many such cellular telephony systems include digital camera subsystems with sensors on the front portion (e.g. the same side as the touch panel and screen) and on the rear portion. When using such integrated systems for capturing images, it is usually the case that the system must not be locked, that is, applications can be invoked and used. Photographic image capture is one such application. Thus, to take a photo, one must invoke a camera application. In addition, for cameras where there are multiple sensors (e.g. front-facing and rear-facing), one must select the sensor to be used. Finally, when a sensor has been chosen, and an object is now in view on the screen, a user may initiate a photographic image capture by either physically pressing a button on the system or touching an icon on the touch-screen panel.

Clearly, after first powering up the integrated system, if it has a locking function, an unlock code must be entered. Now, in functional mode, a camera application must be invoked by touching its icon. Once in camera mode, a front- or rear-facing sensor must be selected. Then, an object is aimed at, and when ready, a button is pressed or an icon touched. Obviously, this can take tens of seconds or more to accomplish.

One way to eliminate both time and complexity would be to have a user's eye gazing at a front-facing camera sensor be the initiating action that precipitates capturing an object's image. There already exist eye tracking technologies that can determine where someone is looking. That function can be used as a way to initiate a photographic image capture, and it involves no pressing of buttons or touching of screen icons—just looking at a camera sensor.

This eye tracking technology can also be used with other software functions, such as a physical or virtual button, to allow the user to select the camera that will be used to take the photograph. For instance, when the user looks at the front-facing camera while pressing a specific button (e.g., volume up), the rear-facing camera will be used.

Using eye tracking technology, one could allow a gaze to unlock a locked system, first, then further gaze time would initiate capturing an object's image. That would eliminate the time required for keying in an unlock code, invoking a camera mode, and taking a photo while eliminating the need to press or touch anything on the system.

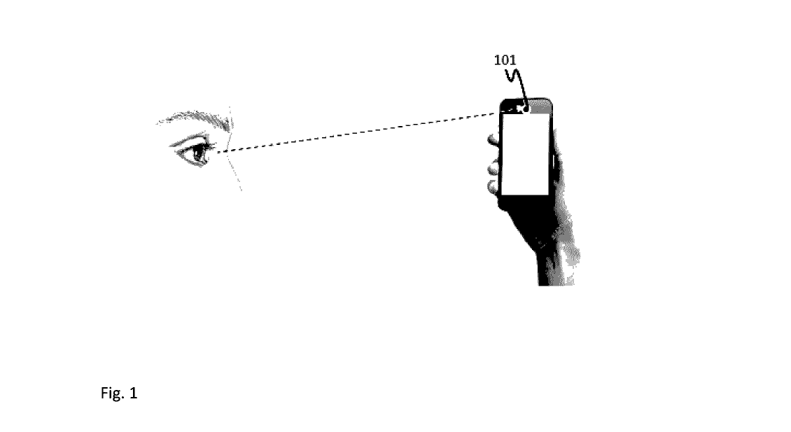

Looking at FIG. 1, a user gazes at a cellular telephony instrument's front-facing camera sensor. Eye tracking technology can quickly determine whether the sensor is being gazed at. In conjunction with other algorithmic conditions, this can be used to initiate a photographic image capture.

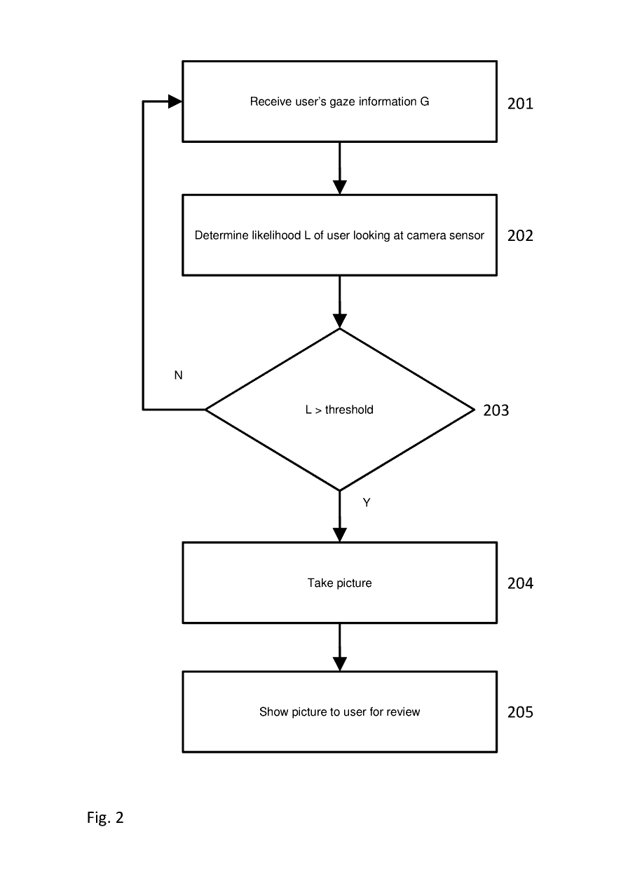

FIG. 2 is a flow chart that illustrates one embodiment of the method disclosed and claimed. An eye tracking subsystem receives user gaze information, G (201). Using the data, a processing subsystem determines the likelihood, L, that a user is looking at a camera sensor (202). When L rises above a threshold value (203), a photo is taken (204), and the image captured is then displayed for the user's review (205). The likelihood, L, of the user looking at the camera sensor may be computed based on one or more of the following: user gaze information G, geometry of the device, distance between the average coordinates of the current fixation and the location of the camera, duration and spread of said fixation, spatial and temporal noise in the gaze coordinates samples, and sampling rate.

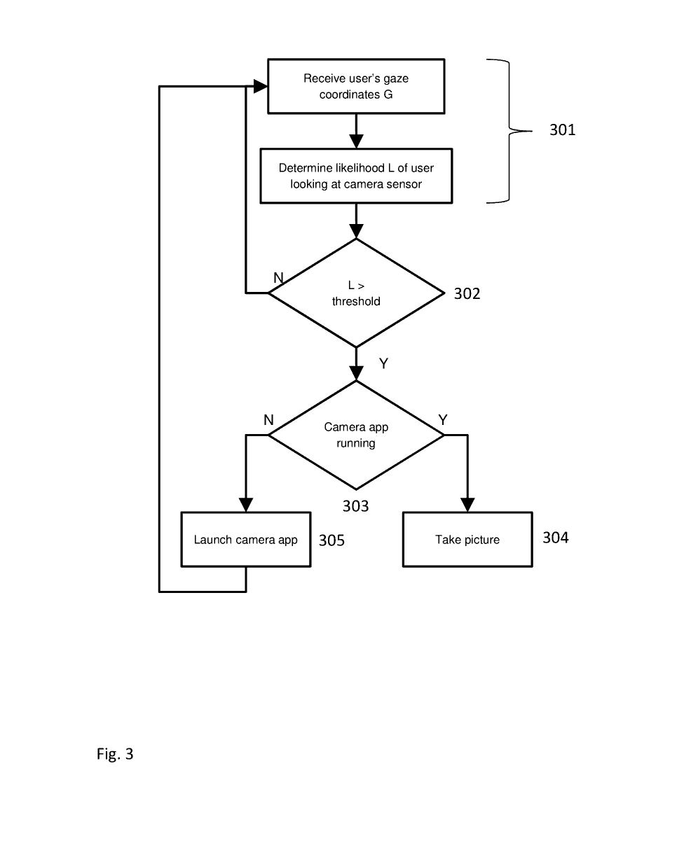

FIG. 3 is a flow chart that illustrates another embodiment of the method disclosed and claimed. As in FIG. 2, gaze information is processed to determine the likelihood of a user looking at a camera sensor (301). When the threshold value is exceeded (302), the program checks whether a camera application is running (303). If so, a picture is taken (304). If not, a camera application is launched (305) followed by a repeat of reception of gaze coordinates, determination of likelihood that someone is looking at the camera sensor, and with a running camera application, a photo is now taken.

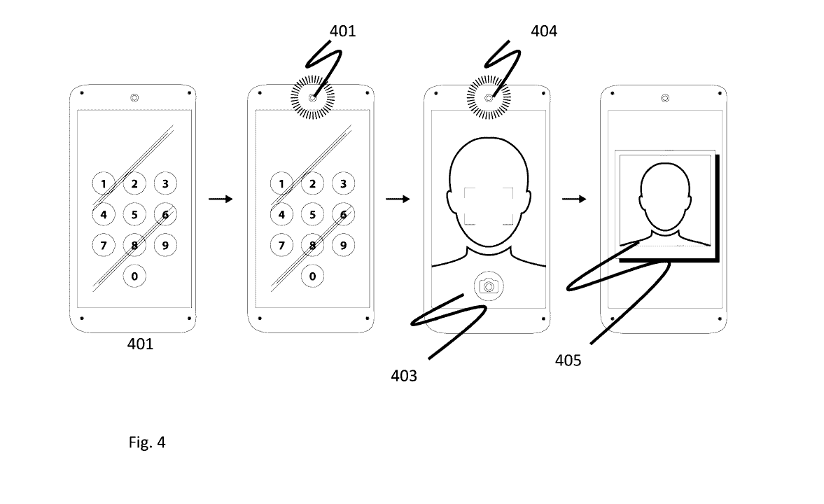

FIG. 4 illustrates another embodiment of the method disclosed and claimed. In a sequence from left to right, one sees a locked system with a touch keypad displayed on the screen (401). That system, presently, would not allow invoking any applications or functions. Next, with someone gazing at the camera sensor (402), a camera application is allowed (403). A further gaze at the sensor (404) in the now active camera application precipitates the image capture, and, in this case, the captured image (405) is stored in a gallery for the user to preview it and either retain or discard it.

Taking one's own photo has become very popular. By looking at the camera sensor, one's eyes are directed at the camera. However, one may divert one's glance to look for the button to press or icon to touch, and the image looks like one's eyes are looking elsewhere. With this method that makes use of gazing at the sensor, one is looking precisely at the camera at the moment of capture.

What is claimed is:

1. A method comprising:
a) Determining an area on a system at which a user is gazing;
b) Determining if said area coincides with a camera sensor on said system;
Repeating a and b if said area does not coincide with said camera sensor;
Initiating a photographic image capture if said area does coincide with said camera sensor.

2. A method as in claim 1 further comprising:
Determining if said system functions are locked;
Initiating, if locked, said photographic camera capture if said area does coincide with said camera sensor.

3. A method comprising:
c) Determining said area on a system at which a user is gazing;
d) Determining if said area coincides with a camera sensor on said system;
Repeating c and d if said area does not coincide with said camera sensor;
Determining if a camera application is active;
Invoking said camera application, if not active, if said area does coincide with said camera sensor.

4. A method as in claim 3 further comprising:
Determining if said system functions are locked;
Invoking, if locked, said camera application if said area does coincide with said camera sensor.
